(19) United States
(12) Patent Application Publication
(10) Pub. No.: US 2012/0133602 A1
(43) Pub. Date: May 31, 2012

(54) COMMUNICATION TERMINAL AND CONTROL METHOD

(75) Inventors: Shunichiro KAMAMOTO, Shizuoka (JP); Katsuyuki SUZUKI, Shizuoka (JP); Makoto TANAKA, Kanagawa (JP); Akira SAITOH, Tokyo (JP); Tsuyoshi GOTANDA, Tokyo (JP); Tomoki HOSAKA, Tokyo (JP); Manabu SHINKAI, Tokyo (JP)

(73) Assignee: TOSHIBA TEC KABUSHIKI KAISHA, Tokyo (JP)

(21) Appl. No.: 13/303,270

(22) Filed: Nov. 23, 2011

(30) Foreign Application Priority Data
Nov. 25, 2010 (JP) 2010-262725

(51) Int. Cl. G06F 3/041

(52) U.S. Cl. 345/173

(57) ABSTRACT

According to one embodiment, a communication terminal includes a contact unit, a detection unit and a sending unit. The contact unit is contacted with the operator of a self-device. The detection unit detects the state of the operator according to the contact state of the contact unit operated by the operator. The sending unit sends the state data detected by the detection unit.

### CROSS-REFERENCE TO RELATED APPLICATION

This application is based upon and claims priority from prior Japanese Patent Application No. 2010-262725, filed on Nov. 25, 2010, the entire contents of which are incorporated herein by reference.

### FIELD

Embodiments described herein relate generally to a communication terminal and a control method.

### BACKGROUND

At present, the well-known communication systems enabling communicators to communicate with each other include telephone system which achieves a communication among telephones and chatting system which achieves a communication among communication terminals and displays words or pictures on the display of each communication terminal.

### DESCRIPTION OF THE DRAWINGS

FIG. 1 is a schematic diagram illustrating a structural example of a communication system adaptive to the communication terminal of this embodiment;

FIG. 2 is a perspective diagram illustrating the sketchy outline of the communication terminal of this embodiment;

FIG. 3 is a diagram illustrating the general hardware components of the communication terminal of an embodiment 1;

FIG. 4 is a block diagram illustrating the functional components of the communication terminal of an embodiment 1;

FIG. 5 is a front diagram of the communication terminal on which the operator is writing words and a hold part is dissipating heat;

FIG. 6 is a diagram illustrating a structural example of a console;

FIG. 7 is a sequence diagram illustrating a chatting communication flow carried out among communication terminals;

FIG. 8 is a flow chart illustrating the data sending sequence of a communication terminal;

FIG. 9 is a flow chart illustrating the data receiving sequence of a communication terminal;

FIG. 10 is a diagram illustrating the general hardware components of the communication terminal of an embodiment 2;

FIG. 11 is a block diagram illustrating the functional components of a communication terminal;

FIG. 12 is a diagram illustrating a structural example of a console stored in the memory unit of a communication terminal;

FIG. 13 is a flow chart illustrating the data sending sequence of a communication terminal.

### DETAILED DESCRIPTION

In existing communication systems, a communicator can only input image data such as word, picture or video and voice data such as voice and music to a communication terminal to convey his state (physical state and mental/psychical state or emotion) to the communication object, and observe the state of the communication object only from the image displayed on the display of the communication terminal or the voice sounded from the loudspeaker of the communication terminal. As a consequence, the communicator can neither express his own state nor understand the state of the communication object well.

In general according to one embodiment, a communication terminal includes a contact unit, a detection unit and a sending unit. The contact unit is contacted with the operator of a self-device. The detection unit detects the state of the operator according to the contact state of the contact unit operated by the operator. The sending unit sends the state data detected by the detection unit.

Further, in general according to one embodiment, a communication terminal includes a contact unit, a receiving unit and a conveying unit. The contact unit is contacted with the operator of a self-device. The receiving unit receives the state data of the operator operating the communication terminal of a communication party. The conveying unit conveys, via the contact unit, the state of the operator operating the communication terminal of the communication party with the state data received by the receiving unit.

Further, in general according to one embodiment, a control method is carried out in a communication terminal comprising a control unit and a contact unit contacted with the operator of a self-terminal. Further, in general according to one embodiment, a control method includes a detection step, a sending step, a receiving step and a conveying step, which are carried out in the control unit. The detection step is a detection unit detects the state of the operator according to the contact state of the contact unit operated by the operator. The sending step is a sending unit sends the state data detected by the detection unit. The receiving step is a receiving unit receives the state data of the operator operating the communication terminal of a communication party. The conveying step is a conveying unit conveys, via the contact unit, the state of the operator operating the communication terminal of the communication party with the state data received by the receiving unit.

One embodiment is described below by reference to accompanying drawings.

Further, in this embodiment, the communication terminal is a device which sketchily conveys the state (physical or mental) of the operator operating a communication terminal serving as a communication object to its own operator. Further, in this embodiment, the communication terminal is a device which conveys the state of its own operator to an operator operating a communication terminal serving as a communication object.

The case is described below that the communication terminal conveys the state of the operator operating a communication terminal serving as a communication object to its own operator according to other stimuli, for example, thermal stimulus (heat dissipation or cooling), except for the image displayed on a display or the voice sounded from a loudspeaker.

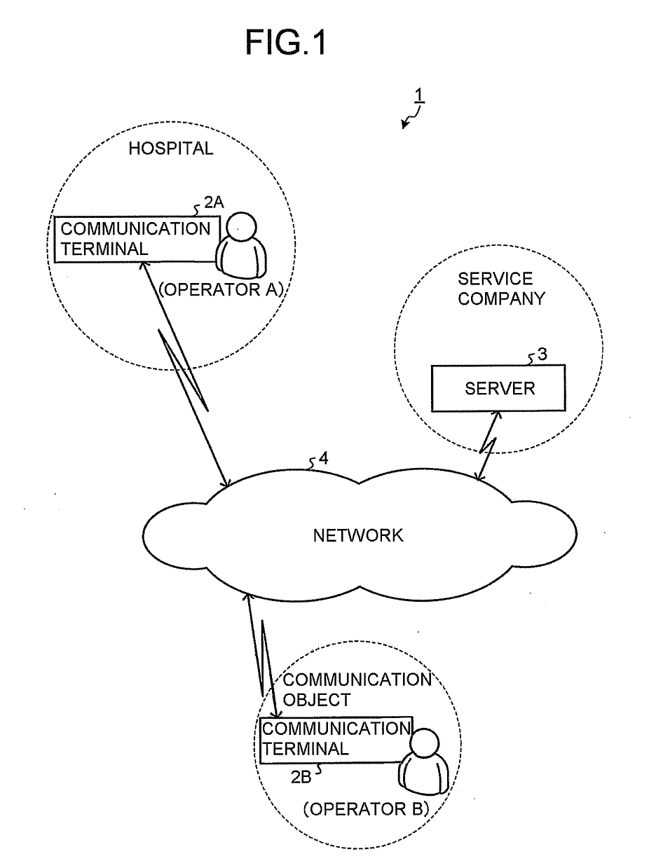

FIG. 1 is a schematic diagram illustrating a structural example of a communication system adaptive to the communication terminal of this embodiment.

As shown in FIG. 1, there are a plurality of communication terminals 2 and a server 3 in the communication system 1, and the communication terminals 2 and the server 3 can communicate with each other via a network 4.

The communication terminal 2 is a terminal which has a function of conveying the state (physical or mental) of the operator operating the communication terminal 2 serving as a communication object to its own operator.

Further, in the example shown in FIG. 1, the communication terminal 2A is a terminal used by a patient in hospital. Further, the communication terminal 2B is a terminal used by a person concerning the patient (e.g. lover, child, relatives and the like).

The server 3 is a computer which offer a service of a connection between the plurality of a communication terminals (e.g. the communication terminal 2A and the communication terminal 2B).

The network 4 is a network (e.g. the Internet) including various communication connectors (e.g. router, not shown) such as router.

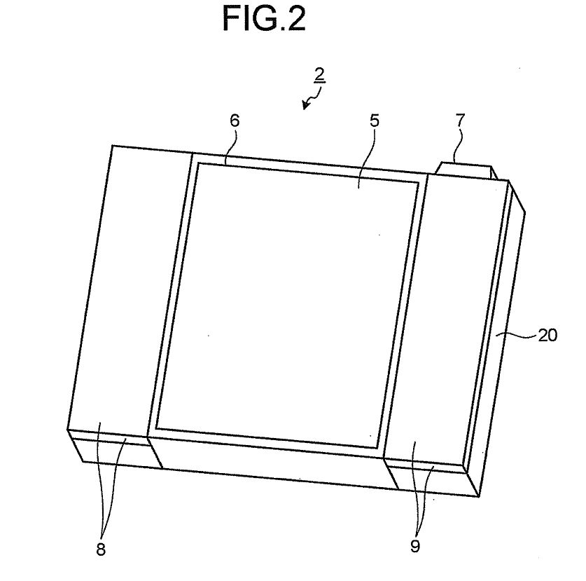

FIG. 2 is a perspective diagram illustrating the sketchy outline of the communication terminal 2 of this embodiment.

As shown in FIG. 2, the communication terminal 2 is portable terminal having a sheet-shaped housing 20. Moreover, a display 5 for displaying the words or pictures manually written or drawn during a chatting and a touch screen 6 that is laminated on the display 5 are arranged on the front side of the housing 20. On the other hand, a power button 7 for powering on or off the device is arranged on a side (the upper side) of the housing 20.

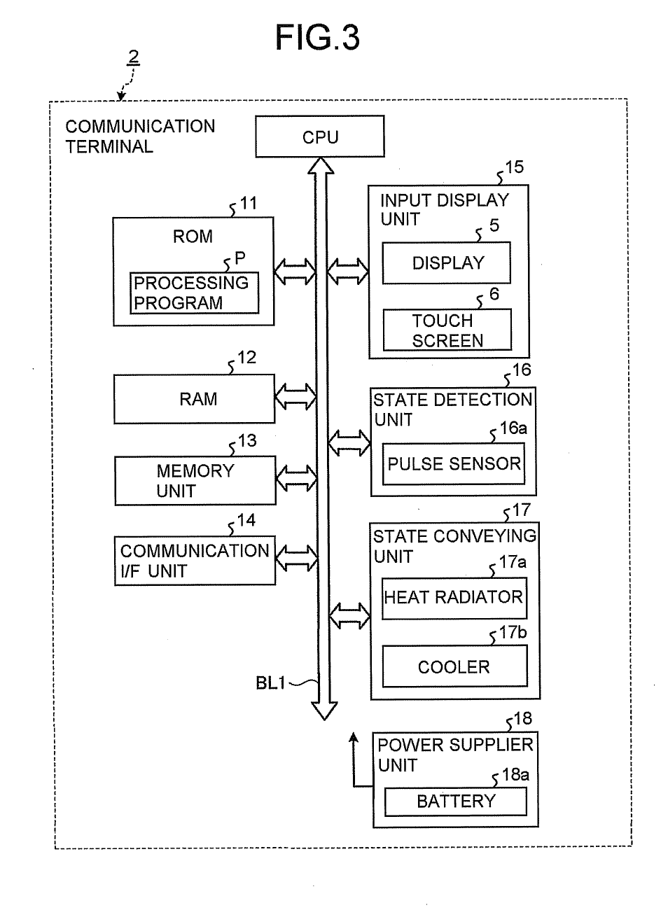

Further, two hold parts (contact parts) 8, 9 are arranged near the left and the right side of the housing that are contacted with and hold by the operator of the communication terminal 2. Besides, each hold part 8 or 9 is changed to a heat-radiating or cooling unit via the aftermentioned state conveying unit 17 (referring to FIG. 3).

FIG. 3 is a diagram illustrating the general hardware components of the communication terminal 2.

As shown in FIG. 3, the communication terminal 2 comprises, for example, a central processing unit (CPU) 10, a read only memory (ROM) 11 that are connected with a bus line BL1 via the CPU 10, a random access memory (RAM) 12, a memory 13, an input display unit 15, a state detection unit 16, a state conveying unit 17 and a communication I/F unit 14, and a power supplier unit 18 which powers each loaded unit.

Here, the CPU 10 controls the whole computer, that is, controls various calculations or the processing carried out on each structural element.

The ROM 11 stores various programs including a processing program P1 for executing the processing sequence of the aftermentioned flow or the data used in these programs.

RAM 12 temporarity stores an operating data which is an input data, a display data and the like, a program which read out from ROM 11 when the computer start and the like.

The memory unit 13 consisting of flashes stores the data needing keeping (e.g. the aftermentioned state conveying control console T) even powered off.

The communication I/F unit 14 is a communication interface unit consisting of well-known communication interface circuits (not shown) which sends or receives the aftermentioned image data or state data via the network 4 in a wired or wireless manner.

The input display unit 15 comprises the aforementioned display 5, a display controller (not shown) controlling various information display on the display 5, the aforementioned touch screen 6 and an input controller (not shown) controlling the input of an operating signal from the touch screen 6. Besides, the display 5 can be, for example, liquid crystals display (LCD).

The detection unit 16 detects the state of the operator of the communication terminal 2 according to contact states of the hold parts 8 and 9 operated by the operator. In this embodiment, the state detection unit 16 comprises a pulse sensor 16a capable of detecting the pulse of the operator and a sensor controller (not shown) for controlling the pulse sensor 16a. Moreover, the state detection unit 16 detects the pulse of the operator via the pulse sensor 16a. In addition, the state detection unit 16 (the pulse sensor 16a) is installed on, for example, each hold part 8 or 9 to detect the state (pulse) of the operator by detecting the hand of the operator holding the hold part 8 or 9.

The state conveying unit 17 conveys the state of an operator operating another communication terminal 2. In this embodiment, the state conveying unit 17 comprises a heat radiator 17a for dissipating heat away from the hold parts 8 and 9, a heat radiator controller (not shown) for controlling the heat radiator 17a, a cooler 17b for cooling the hold parts 8 and 9, and a cooling controller (not shown) for controlling the cooling of the cooler 17b. Moreover, the state conveying unit 17 dissipates heat away from or cools the hold parts 8 or 9 via the heat radiator 17a and the cooler 17b, thereby conveying the state (e.g. excited, frustrated) of the operator of the communication object to the operator of the self-terminal.

The power supplier unit 18, a power supply for powering the aforementioned loaded units (10-17), comprises, for example, a battery 18a detachable with respect to a battery holder (not shown) and a power controller (not shown) controlling the power supply of the battery 18a.

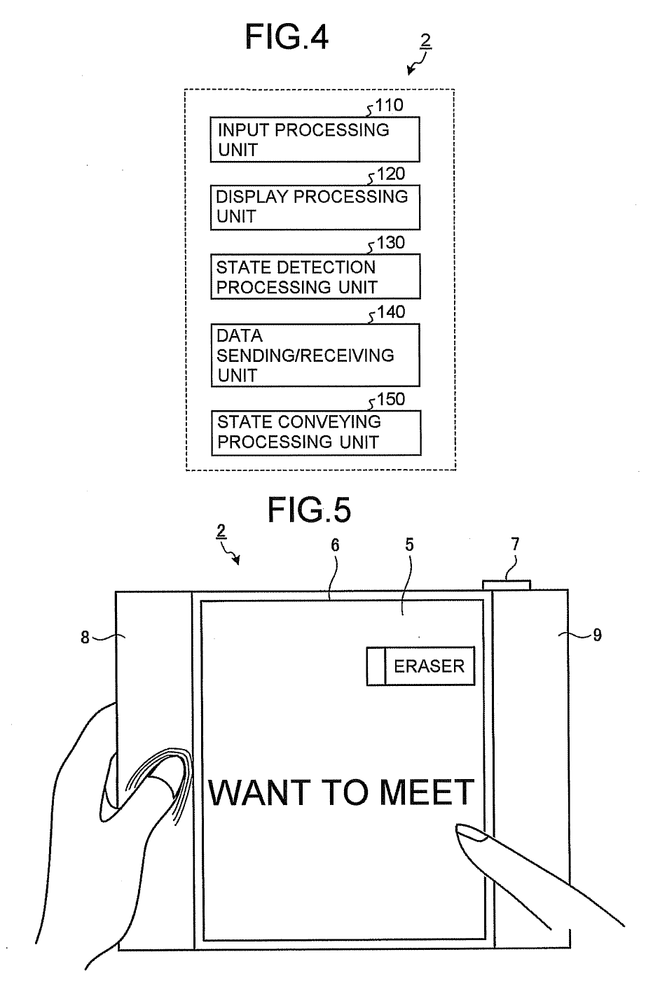

FIG. 4 is a block diagram illustrating the functional components (that is, software components) of the communication terminal 2 which are achieved by executing the processing program P1 of the CPU 100 stored in a memory unit such as the ROM 11 on the RAM 12.

As shown in FIG. 4, the communication terminal 2, as a functional component, comprises an input processing unit 110, a display processing unit 120, a state detection processing unit 130, a data sending/receiving unit 140 and a state conveying processing unit 150.

Here, the input processing unit 110 inputs the coordinate data representing the track of the finger or touch pen of the operator via the touch screen 6 or an input controller (not shown).

The display processing unit 120 displays on the display 5 the image of the track of the hand or touch pen of the operator (that is, a hand-written word or hand-drawn picture) (referring to FIG. 5) based on the coordinate data input by the input processing unit 110, and outputs image data representing the track image to the data sending/receiving unit 140.

FIG. 5 is a front view of the communication terminal 2 on which the operator is writing words and the hold parts 8 and 9 are dissipating heat.

As shown in FIG. 5, in the communication terminal of this embodiment, the operator can write words or draw pictures freely on the touch screen 6 manually or with a touch pen. Besides, in this embodiment, an icon 61 ‘eraser’ is displayed on the display 5 with which the operator can erase the word or picture displayed on the display 5.

Back to FIG. 4, the state detection processing unit 130 detects the state of the operator using the state detection unit 16. Specifically, the state detection processing unit 130 detects the pulse of the operator of the hold parts 8 and 9 via the pulse sensor 16a at certain intervals and outputs the detected pulse to the data sending/receiving unit 140 as state data of the operator.

The data sending/receiving unit 140 sends and receives various data via the communication I/F unit 14. Specifically, the data sending/receiving unit 140 sends the image data or state data input from the display processing unit 120 or the state detection processing unit 130 or receives the image data or state data sent from another communication terminal 2 of the communication object.

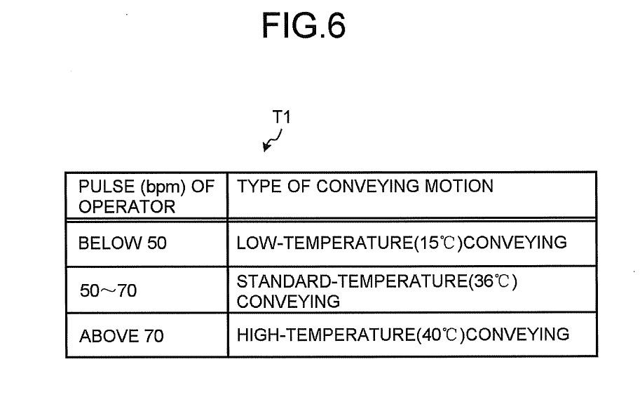

Based on the state data received by the data sending/receiving unit 140 from another communication terminal 2 of the communication object, the state conveying processing unit 150 conveys the state of the operator operating the another communication terminal 2 of the communication object using the state conveying unit 17. Specifically, the state conveying processing unit 150 determines a conveying type according to the state data of the operator specified by the received state data and the setting information stored in the console T1 of the memory unit 13 (referring to FIG. 6) and carries out a conveying action corresponding to the determined type.

FIG. 6 is a diagram illustrating a structural example of the console T1.

As shown in FIG. 6, the console T1 is used for determining the type of a conveying action to be carried out by the state conveying unit 17 according to the received state data and registering the ranges of the pulse data that is set as state data and the types of the conveying actions carried out by the state conveying unit 17 that are set corresponding to the ranges.

In addition, in the example shown in FIG. 6, the conveying action type ‘low-temperature (15 degrees) conveying’ corresponds to the pulse data range ‘below 50 (bpm)’; the conveying action type ‘standard-temperature (36 degrees) conveying’ corresponds to the pulse data range ‘50 (bpm)-70 (bpm)’; and the pulse data range ‘high-temperature (40 degrees) conveying’ corresponds to the pulse data range ‘above 70 (bpm)’.

Besides, in this embodiment, the called ‘low-temperature (15 degrees) conveying’ refers to an action of driving the cooler 17b by changing the temperatures of the hold parts 8 and 9 to 10 degrees or so; the called ‘standard-temperature (36 degrees) conveying’ refers to an action of driving the heat radiator 17a (together with the cooler 17b if needed) by changing the temperatures of the hold parts to about 36 degrees (the average body temperature); and the called ‘high-temperature (40 degrees) conveying’ refers to an action of driving the heat radiator 17a by changing the temperatures of the hold parts 8 and 9 to 40 degrees or so.

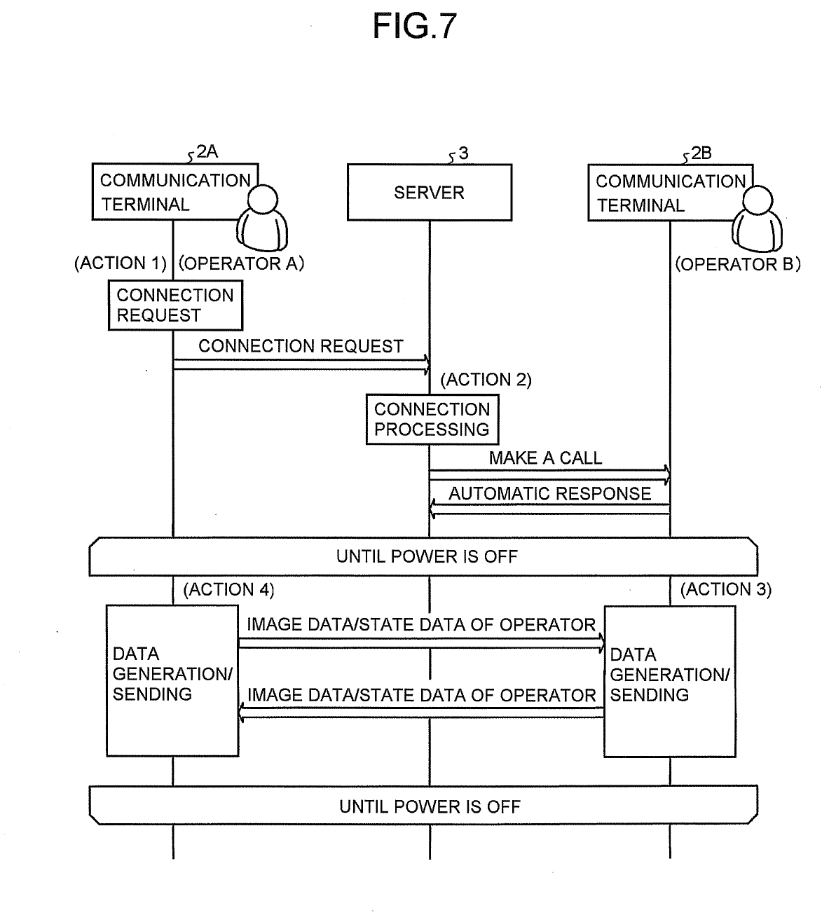

Each processing action carried out in the above-described communication system 1 is described below with reference to FIG. 7-FIG. 9.

FIG. 7 is a sequence diagram illustrating a chatting communication flow carried out between communication terminals 2A and 2B in the communication system 1.

As shown in FIG. 7, in this sequence, first, the operator A of the communication terminal 2A presses down a power button 7 to power on the communication terminal or selects a communication starting icon displayed on the display 5 via the touch screen 6 to enable the communication terminal 2A to send a connection request (action 1) to the server 3,

then, the server 3 selects the communication terminal 2B of a corresponding communication object according to the registration information representing a communication terminal and establishes (action 2) a communication connection between the communication terminals 2A and 2B through an automatic response,

and at last, image data or state data is repeatedly generated, sent or received (actions 3 and 4) between the communication terminals 2A and 2B until the chatting communication between the communication terminals 2A and 2B is ended.

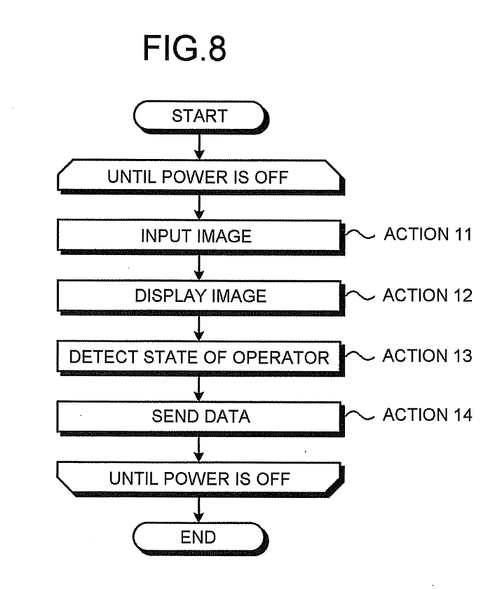

FIG. 8 is a flow chart illustrating the data sending sequence of the communication terminal 2.

As shown in FIG. 8, in this processing, actions 11-14 are repeatedly carried out from the moment the operator operates a power button 7 to switch on the power supply of the communication terminal 2 to the moment the operator operates the power button 7 to switch off the power supply of the communication terminal 2.

That is, in action 11, if the operator makes an input on the touch screen 6 with a finger or a touch pen, then the input processing unit 110 generates coordinate data representing the input track and outputs the coordinate data to the display processing unit 120.

In the following action 12, the display processing unit 120 displays the track image (the words or picture manually written or drawn by the operator) on the display 5 according to the input coordinate data and synchronously outputs image data representing the track image to the data sending/receiving unit 140.

In the following action 13, the state detection processing unit 130 detects the pulse of the operator with the pulse sensor 16a as the state of the operator, generates state data representing the pulse detected, and outputs the state data to the data sending/receiving unit 140.

In the following action 14, the data sending/receiving unit 140 sends the input image data or state data.

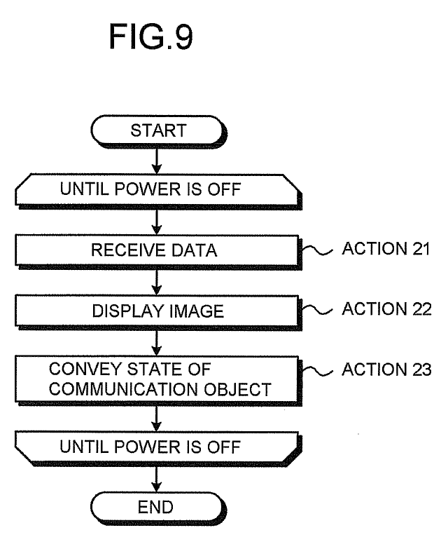

FIG. 9 is a flow chart illustrating the data receiving sequence of the communication terminal 2.

As shown in FIG. 9, in this processing, actions 21-23 are repeatedly carried out from the moment the operator operates a power button 7 to switch on the power supply of the communication terminal 2 to the moment the operator operates the power button 7 to switch off the power supply of the communication terminal 2.

That is, in action 21, the data sending/receiving unit 140 receives image data and state data from another communication terminal 2 of the communication object, and outputs the received image data to the display processing unit 120 and the received state data to the state conveying processing unit 150.

In the following action 22, the display processing unit 120 displays an image on the display 5 with the input image data.

In the following action 23, the state conveying processing unit 150 drives the heat radiator 17a or cooler 17b of the state conveying unit 17 according to the input state data conveying the state of the operator of the communication object and the setting information of the console T1 shown in FIG. 6. Specifically, as the processing of the action 23, for instance, if learning, by analyzing the received state data, that the pulse of the operator of the communication object is 75, then the state conveying processing unit 150 selects a conveying action type ‘high-temperature (40 degrees) conveying’ by reference to the setting information of the console T1. Moreover, the state conveying processing unit 150 controls the heat dissipation of the heat radiator 17a by changing the temperatures of the hold parts 8 and 9 to 40 degrees or so.

In accordance with the embodiment above, apart from images or voice, other parameters (heat and the like) can also be displayed on the display to convey the state (pulse and the like) or a state change of the communicator to the communication object. Besides, the communicator can strongly feel the existence (feel warm) of the other party.

### Embodiment 2

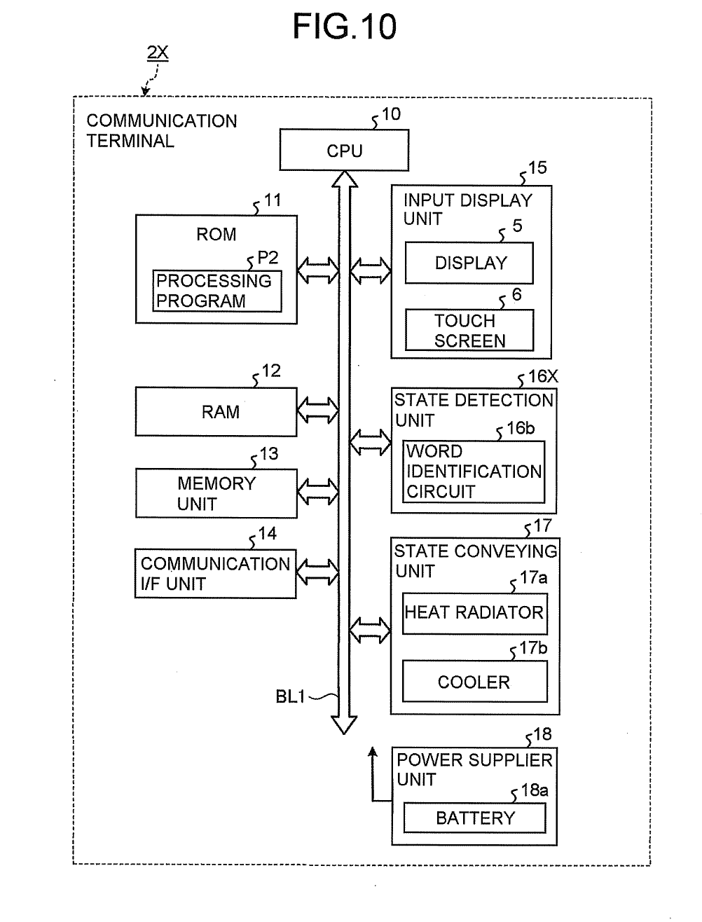

Embodiment 2 is described below with reference to FIG. 10-FIG. 13.

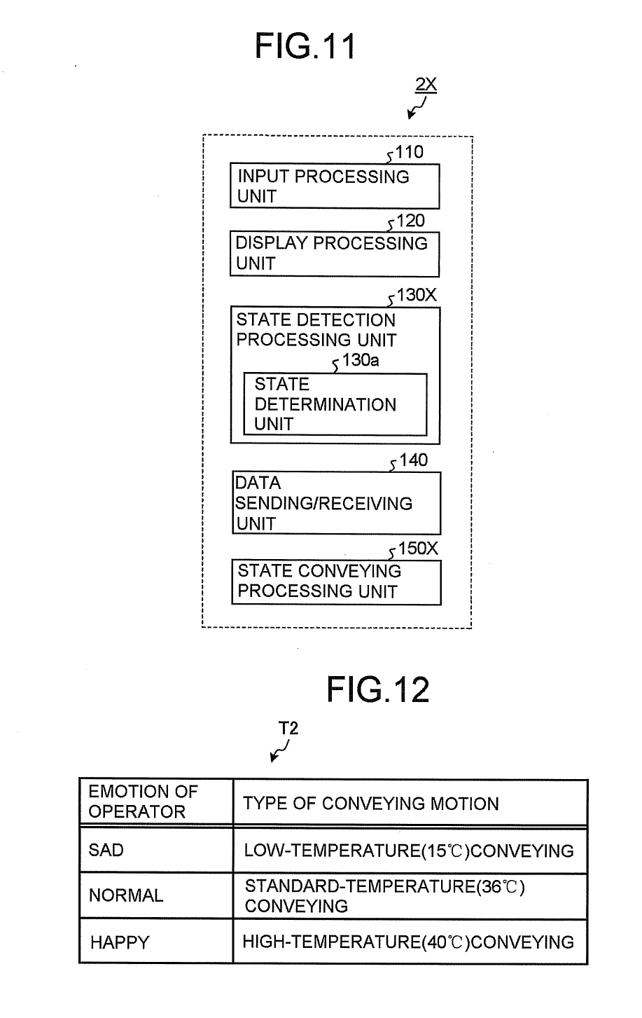

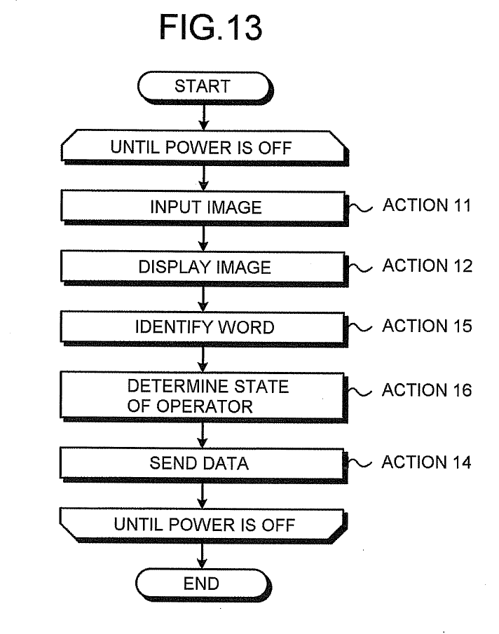

FIG. 10 is a diagram illustrating the general hardware components of a communication terminal 2X in an embodiment 2. FIG. 11 is a block diagram illustrating the functional components of the communication terminal 2X. FIG. 12 is a diagram illustrating a structural example of a console T2 stored in the memory unit of the communication terminal 2X. FIG. 13 is a flow chart illustrating the data sending sequence of the communication terminal 2X. Further, in the following description, the components and processing the same as those in embodiment 1 are omitted.

As shown in FIG. 10, compared in hardware component with the communication terminal 2 of the embodiment 1, the communication terminal 2X is different in the component of the state detection unit 16X in which the pulse sensor 16a is replaced with a word identification circuit 16b. The word identification circuit 16b uses well-known word identification algorithms such as optical character reader (OCR) to identify the hand-written words input by the input display unit 15, and then identifies preset specific words (e.g. ‘want to meet’, ‘I love you’, ‘lonely’, ‘thank you’) and analyzes the state (emotion) of the operator according to the identified words.

Further, as shown in FIG. 11, compared in software component with the communication terminal 2 of the embodiment 1, the communication terminal 2X is different in the state detection processing unit 130X and the state conveying processing unit 150X which carry out different processing actions. That is, the state detection processing unit 130X comprises a state determination unit 130a, which identifies the words manually written by the operator and limits specified words, and determines the state of the operator according to the limited words.

As shown in FIG. 12, the console T2 is a device for determining the type of a conveying action to be carried out by the state conveying unit 17 according to the state of the operator determined by the state determination unit 130a. Moreover, the console T2 registers emotion information representing the emotional state of the operator as well as information representing conveying action types of the state conveying unit 17 that is set corresponding to the emotion information. In addition, in the example shown in FIG. 12, the conveying action type ‘low-temperature (15 degrees) conveying’ corresponds to the emotion information ‘sad’; the conveying action type ‘standards-temperature (36 degrees) conveying’ corresponds to the emotion information ‘normal’; and the conveying action type ‘high-temperature (40 degrees) conveying’ corresponds to the emotion information ‘happy’.

Therefore, after determining the identified word is a first word such as ‘lonely’ which is assumed to represent the emotion ‘sad’ the operator, the state determination unit 130a determines the emotion of the operator to be ‘sad’; after determining the identified words are ‘I love you’ which are assumed to represent the emotion ‘happy’ the operator, the state determination unit 130a determines the emotion of the operator to be ‘happy’; and after determining the identified words are other words except for the first and the second words, the state determination unit 130 determines the emotion of the operator to be ‘normal’.

Moreover, the state detection processing unit 130X outputs the state data representing the state (emotion such as ‘sad’, ‘normal’ and ‘happy’) of the operator determined by the state determination unit 130a to the output processing unit 110, as it does in embodiment 1.

Further, when receiving state data representing the emotion (e.g. ‘sad’, ‘normal’, ‘happy’ and the like) of the operator operating another communication terminal serving as the communication object from the data sending/receiving unit 140, the state conveying processing unit 150X determines a conveying action type according to the emotion of the operator specified by the received state data and the setting information stored in the console T1 of the memory unit 13 (referring to FIG. 6) and carries out a conveying action corresponding to the determined type.

For instance, after receiving the state data representing ‘sad’, the state conveying processing unit 150X selects ‘low-temperature (15 degrees) conveying’ from the console T2 as a conveying action type, and in accordance with the conveying action of the selected type, the cooler 17b is driven by changing the temperatures of the hold parts 8 and 9 to 15 degrees or so; after receiving the state data representing ‘happy’, the state conveying processing unit 150X selects ‘high-temperature (40 degrees) conveying’ from the console T2 as a conveying action type, and in accordance with the conveying action of the selected type, the heat radiator 17a is driven by changing the temperatures of the hold parts 8 and 9 to 40 degrees or so; and after receiving the state data representing ‘normal’, the state conveying processing unit 150X selects ‘standard-temperature 36 degrees) conveying’ from the console T2 as a conveying action type, and in accordance with the conveying action of the selected type, the heat radiator 17a or the cooler 17b is driven by changing the temperature of the hold parts 8 and 9 to 36 degrees or so.

Moreover, compared with the data sending sequence shown in FIG. 8, the data sending sequence shown in FIG. 13 is only different in that the action 13 is replaced by an action 15 and only the state data used in the action 14 is generated by the aforementioned method. In addition, the data receiving sequence of the communication terminal 2X is substantially identical to that shown in FIG. 9 but slightly different in that the aforementioned method is only used in the action 13 to convey the state.

In accordance with the above-descried embodiments, the terminal is downsized or lightened as there is no need of providing a specific sensor for detecting the physical state of the operator.

The present invention, although illustrated above with reference to exemplary embodiments, is not limited to these embodiments.

For instance, in the embodiments above, the pulse of an operator is detected as the state of the operator, but the present invention is not limited to this, other vital signs (e.g. ‘body temperature’, ‘blood pressure’, ‘breath’ and the like) can also be detected.

Further, in the embodiments above, the device for conveying the state of an operator is described on condition that the device is provided with a heat radiator and a cooler; the present invention is, however, not limited to this, other conveying devices can also be used herein. Specifically, for instance, a light-emitting device such as a light-emitting diode can also be controlled in flashing frequency or be turned-on/off to convey the state change of the communication object. Further, the state change of the communication object can be conveyed by changing the display color of the word or picture that is written or drawn by the communication object and displayed on the display 5. Additionally, the state change of the communication object can also be conveyed by vibrating the hold parts 8 and 9 with a vibrator (a vibrating unit), for example, by the vibrating unit cause the hold parts 8 and 9 a vibration imitate the pulse of the operator of the communication party.

Further, although in the embodiments above, the description is given based on that the hold parts 8 and arranged at the left and the right end of the communication terminal 2 (2X) are heat-dissipated or cooled to convey the state of the communication object (operator), the present invention is not limited to this, another part of the communication terminal 2 (2X) can also be heat-dissipated or cooled. Specifically, a transparent sheet-shaped heat-conveying component (the contact unit) capable of covering the whole touch screen 6 can be used to dissipate heat away from or cool the communication terminal 2 (2X).

In addition, although in the embodiments description is given based on that the words written by the operator are identified and specific words are limited to determine the state of the operator, the present invention is not limited to this, the state of the operator can also be determined according to the waving of the writing hand of the operator or the writing speed of the operator. For instance, it is determined that an operator writing fast is energetic and, on the other hand, an operator writing slowly is listless.

In addition, although in the embodiments above, a description is given based on that the temperatures of the hold parts 8 and 9 are changed to three temperature ranges ‘low-temperature (15 degrees)’, ‘standard-temperature (36 degrees)’ and ‘high-temperature (40 degrees)’ according to the pulse of the communication object, it should be understood that the temperatures of the hold parts 8 and 9 can also be changed to the body temperature of the operator of the communication object. Further, although in the embodiments above, a communication is achieved through the Internet or the server, a communication can also be achieved between communication terminals using wireless local area network technology and the like.

Further, as computer products, the processing programs P1 and P2 executed in the communication terminal can be pre-programmed in a memory unit such as an ROM, or stored as installable or executable files and provided to a computer-readable storage medium, or provided or distributed by networks such as the Internet.

In addition, the hardware or software components of the communication terminal, the device and method for conveying the state of an operator and the processing sequences described in the embodiments above are illustrated only as examples which are not to be construed as limiting the present invention.

What is claimed is:

1. A communication terminal, comprising:
a contact part configure to contact with an operator of a self-device;
a detection unit configure to detect a state of the operator according to the contact state of the contact part operated by the operator; and
a sending unit configure to send a date of the state data detected by the detection unit.

2. The device according to claim 1, wherein
the detection unit detects the state of the operator according to a waving level of a writing hand or a writing speed.

3. The device according to claim 1, wherein
the detection unit detects a pulse of the operator as the state of the operator.

4. The device according to claim 1, wherein
the detection unit detects a temperature of the operator as the state of the operator.

5. The device according to claim 1, wherein
the detection unit detects a blood pressure of the operator as the state of the operator.

6. A communication terminal, comprising:
a contact part configure to contact with an operator of a self-terminal;
a receiving unit configure to receive a date of a state of the operator operating the communication terminal of a communication party; and
a conveying unit configure to convey via the contact unit, the state of the operator operating the communication terminal of the communication party with the data received by the receiving unit.

7. The device according to claim 6, wherein
the conveying unit conveys the state of the operator of the communication party by heat.

8. The device according to claim 7, further comprising:
a hold part configure to hold by the operator;
a heat radiator unit configure to dissipate heat away from the hold part;
a cooler unit configure to cool the hold part, wherein
the conveying unit conveys the state change of the operator of the communication party to the operator of the self-terminal by changing the temperature of the hold part with the heat radiator unit or the cooler unit.

9. The device according to claim 8, wherein
the conveying unit conveys the state of the operator of the communication party to the operator of the self-terminal by changing the temperature of the hold part to the temperature of the operator of the communication party with the heat radiator unit or the cooler unit.

10. The device according to claim 6, wherein
the conveying unit conveys the state of the operator by vibration.

11. The device according to claim 10, further comprising:
a hold part configure to hold by the operator; and
a vibrating unit configure to vibrate the hold part, wherein
the conveying unit conveys the state of the operator of the communication party to the operator of the self-terminal by the vibrating unit cause the hold part a vibration imitate the pulse of the operator of the communication party.

12. A control method carried out in a communication terminal, wherein
the communication terminal comprises a control unit and a contact part contacted with an operator of a self-terminal; and
the following steps are carried out in the control unit:
a detection step in which a detection unit detects a state of the operator according to the contact state of the contact part operated by the operator;
a sending step in which a sending unit sends a date of the state detected by the detection unit.
a receiving step in which a receiving unit receives the data of the operator operating the communication terminal of a communication party; and
a conveying step in which a conveying unit conveys, via the contact part, the state of the operator operating the communication terminal of the communication party with the data received by the receiving unit.
